(19) United States
(12) Patent Application Publication
(10) Pub. No.: US 2015/0347155 A1
(43) Pub. Date: Dec. 3, 2015

(54) SWITCHING BETWEEN OPERATIONAL CONTEXTS

(71) Applicants: Michael Rothman, Puyallup, WA (US); Vincent J. Zimmer, Federal Way, WA (US); Chee Keong Sim, Serendah (MY); Tze Ming Hau, Seremban (MY); Yi Holger Qian, Shanghai (CN); Yu Rui, Shanghai (CN); Jian Javen Wang, Shanghai (CN)

(72) Inventors: Michael Rothman, Puyallup, WA (US); Vincent J. Zimmer, Federal Way, WA (US); Chee Keong Sim, Serendah (MY); Tze Ming Hau, Seremban (MY); Yi Holger Qian, Shanghai (CN); Yu Rui, Shanghai (CN); Jian Javen Wang, Shanghai (CN)

(21) Appl. No.: 13/995,691

(22) PCT Filed: Oct. 28, 2011
(86) PCT No.: PCT/US2011/058192

§ 371 Date: Jun. 5, 2015

(51) Int. Cl. G06F 9/44; G06F 1/32

(52) U.S. Cl. CPC G06F 9/4418; G06F 1/3203; G06F 9/441

(57) ABSTRACT

Multiple operational contexts are called up from a Standby power state of a computing device. The operational contexts run on one or more operating systems of the computing device. When a desired operational context is chosen, such as by activation through a user initiated act or hot key, the operating system supporting the desired operational context is booted up from the Standby power state.

### BACKGROUND

Mechanisms exist for saving power by suspending computer execution and for implementing a multi-boot computing device. In systems of the prior art, a single operating system (OS) is typically booted at a time. If a second OS is needed, the computing device is powered down and firmware rebooted. There may be standards governing the boot process, such as the basic input/output system (BIOS) boot specification and/or the extensible firmware interface (EFI) boot manager.

Furthermore, there may be standards and specifications that govern power management for a computing device. For example, U.S. Energy Star ratings provide for an exemplary requirement for a machine (computing device) to only dissipate 100 Watts. The Advanced Configuration & Power Interface or ACPI (see http://www.acpi.info) is an industry specification jointly developed by Intel Corporation, Microsoft Corporation, Toshiba Corporation and Hewlett-Packard Company to identify standards for managing power. Sleep states and transitions are defined by the ACPI specification. For instance, there is an ACPI specification that defines how to build hardware to support an S4 sleep state or Hibernate state. In S4 sleep state the computing device goes into deep sleep to save power, In S4 sleep state, an OS of the computer device takes all of its memory contents and saves them to a disk file (hard disk). Another state is S3 sleep state that is considered a Standby state. In S3, contents are retained in system random access memory (RAM). A small amount of power is provided to the system RAM and the chipset to catch or listen for a wake event, such as a lid of a laptop opening or activation of a hot key. In contrast, for S4 sleep state, everything is powered off

A computing device may use multiple operational contexts, where applications run on the same or different OS. For example, a user may play a game running, on a first OS, such as Windows™ Playing the game is one operational context. The user then desires to use a touch pad running on a second OS, such as Linux OS. The touch pad application is another operational context. Going between operational contexts may involve an event such as closing the lid of a laptop computing device, or activating a designated hot key on the computing device. Considering that going between operational contexts involves shutting down and bringing up different OS, the time between operational contexts may be significant. It would be highly desirable to quickly go between operational contexts with minimal delay, it is to be understood that virtual machines running on a computing device may provide minimal delay between operational contexts. Running virtual machines require significant computing resources and power of the computing device. This tray become problematic when the computing device has limited resources, including power resources. This is particularly the case when the computing device is a small form factor device, such as a tablet or ultra book. Therefore, it would be desirable to be able to go between operational contexts with minimal delay, computing resources. and power.

### BRIEF DESCRIPTION OF THE DRAWINGS

The detailed description is described with reference to accompanying figures. In the figures, the left-most digit(s) of a reference number identifies the figure in which the reference number first appears. The same numbers are used throughout the drawings to reference like features and components.

FIG. 1 is an example flow chart for switching between operational contexts.

FIG. 2 is an example flow chart for running an operating system when switching between operational contexts.

FIG. 3 is an example flow chart for initiating and running a system management (mode) interrupt or SMI handler when switching between operational contexts.

FIG. 4 is an example flow chart for preserving switched operating system context when switching between operational contexts.

FIG. 5 is an example flow chart for resuming target switch context when switching between operational contexts.

FIG. 6 is an example flow chart for jumping to an operating system resume vector when switching between operational contexts.

FIG. 7 is an example flow chart for waking from sleep state in pre extensible firmware interface (Pre-EFI or PEI) implemented in basic input/output system (BIOS), when switching between operational contexts.

FIG. 8 is an example flow chart for waking from sleep state in driver execution environment (DXE) implemented in basic input/output system (BIOS), when switching between operational contexts.

FIG. 9 is a block diagram of an example architecture of a computing device that implements switching between operational contexts.

FIG. 10 is a block diagram of an example memory that implements switching between operational contexts.

### DETAILED DESCRIPTION

Switching between operational contexts in a computing device makes use of a low power state, such as a Standby or S3 sleep state. Using the low power state may allow for minimal time going between operational contexts and/or calling up an operational context.

### Overview

Described herein are methods, computing devices, and computer-readable storage media that allow switching between (e.g., changing) operational contexts in a computing device, implementing a low power state. Typically a Standby state, such as an S3 state, is used for a single process, and single instance; however, described herein are methods, computing devices, and computer-readable storage media that use a Standby or S3 slate for N number of operational contexts. For instance, the Standby state or S3 state may be used to switch operational context in a time efficient and responsive manner. Operations may be platform agnostic or OS agnostic, and implemented using the basic input/output system (BIOS) of the computing device.

In the following detailed description, numerous specific details are set forth in order to provide a thorough understanding of the invention. However, it will be understood by those of ordinary skill in the art that the present invention may be practiced without these specific details, In other instances, well-known methods, procedures, components and circuits have not been described in detail so as not to obscure the present invention.

Some portions of the detailed description, which follow, are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

Unless specifically slated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, or transmission devices. The terms “a” or “an”, as used herein, are defined as one, or more than one, The term plurality, as used herein, is defined as two, or more than two. The term another, as used herein, is defined as, at least a second or more, The terms including and/or having as used herein, are defined as, but not limited. to, comprising. The term coupled as used herein, is defined as operably connected in any desired form for example, mechanically, electronically, digitally, directly, by software, by hardware and the like. It should be understood that the present invention may be used in a variety of applications.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, and/or a wireless communication device. Such devices are collectively referred to as “computing device” herein.

A computing device implements a low power state, for example the computing device uses the ACPI specification and is able to go into an S3 sleep state or Standby state. The computing device includes one or more OS, including a “full” OS, a special purpose OS, an OS/application, etc. Applications running on the computing device may run on their own operational context. Each OS and operational context are compatible or make use of the low power state (e.g., Standby or S3 state). An operational context or OS may be called up, or switched from one OS/operational context to another, by a user action, such as closing a lid on a laptop computing device and/or activating a hot key on the computing device. It is to be understood that other triggering events may be implemented, either pre-programmed and/or integrated as part of the computing device, and/or programmed by a user.

The methods and processes described may be implemented as part of a basic input/output system (BIOS) of the computing device. Furthermore, the computing device implements particular BIOS boot specification and/or extensible firmware interface (EFI) boot manager specifications. The methods and processes also may make use of defined system management mode (SMM) operations, including a SMM interrupt (SMI) operation, and in particular a SMI handler. The SMI handler is particularly directed to detecting and addressing “errors” when booting an OS.

### Example Process

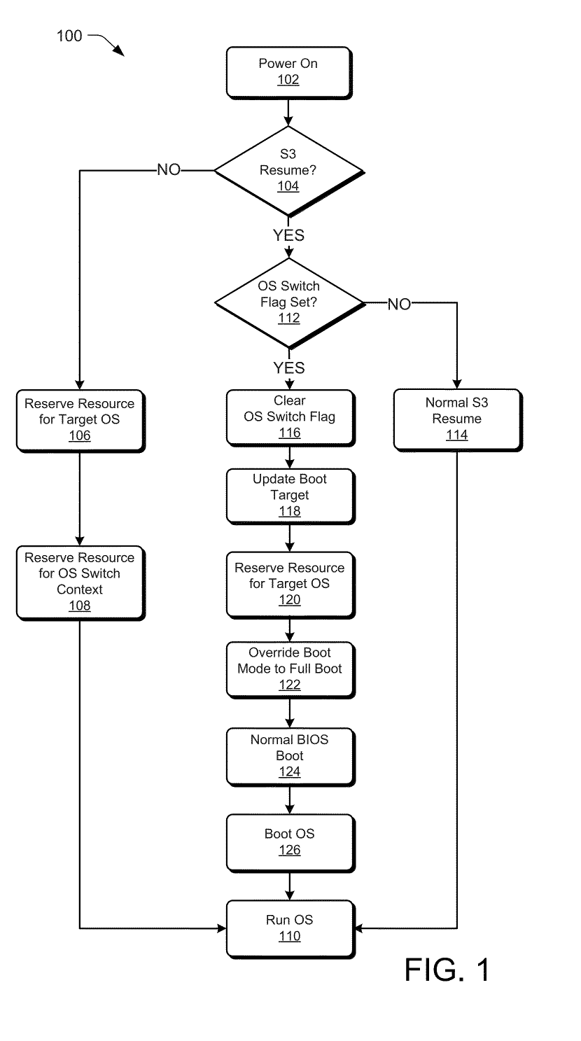

Referring now to the drawings. FIG. 1 shows an example process 100 for switching between operational contexts. At block 102, a presumption is made that power is turned on a computing device, although the computing device may be in one of several sleep states. A determination is made if the computing device is in a Standby state, for example the S3 sleep state. In particular, at block 104, the determination is made if the computing device is resuming from a Standby or S3 sleep state.

If the computing device is not resuming from a Standby or S3 sleep state, following, the “NO” branch of block 104, at block 106, the computing device reserves resources for a target OS, where the target OS is defined as the OS that the computing device is to use for a particular operational context. At block 108, resources are reserved for OS switch context. For example, OS may be switched from a Windows™ OS to a Linux OS. At block 110, the desired OS is initiated.

If the computing device is coming from a Standby or S3 sleep state, following the “YES” branch of block 104, at block 112 a determination is made if an OS switch flag has been set. In particular, at block 112 the determination is directed to whether the OS is to be switched or changed to support a desired operational context. If the determination is to use the same OS as previous, following the “NO” branch of 112, at block 114, normal resume from the Standby or S3 state is performed. Then at block 110, the OS is initiated.

If the computing device 100 is to change or switch OS, following the “YES” branch of block 112, the computing device is going from a Standby or S3 state in one OS, to an operational context that runs on another OS. Therefore, the other OS needs to be awakened or booted up.

At block 116, the OS switch flag is cleared for maintenance purposes. At block 118, an update to boot target is performed. For each OS, memory is reserved in order for the respective OS to boot up from, A resume is performed from the respective memory location of the desired OS. At block 120, resources for the target OS are reserved. At block 122, an override is performed from boot mode to a full boot of the target/switched OS. At block 124, at the BIOS of the computing device, a boot is performed to initiate the different OS or target OS. At block 126, the target OS is booted, and at block 110 the OS is initiated.

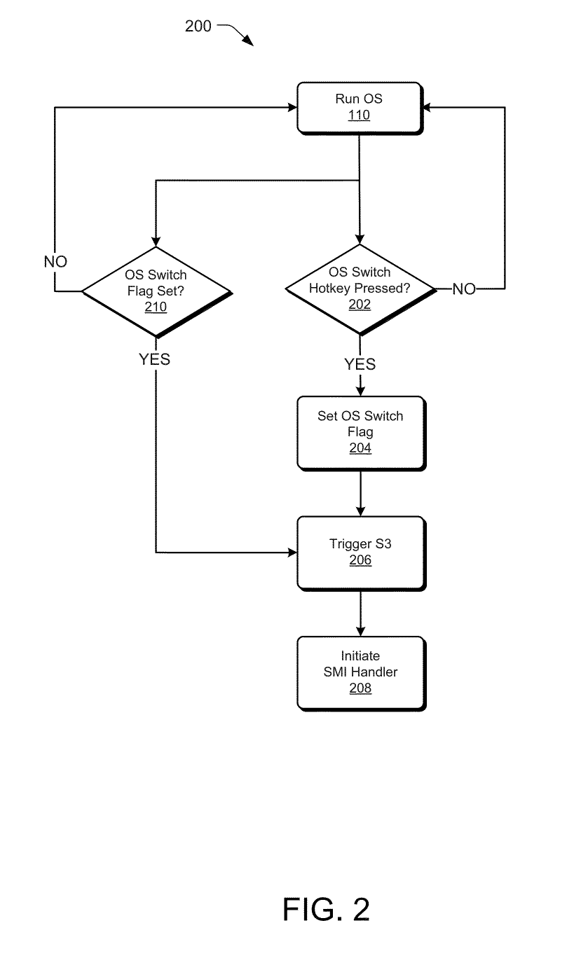

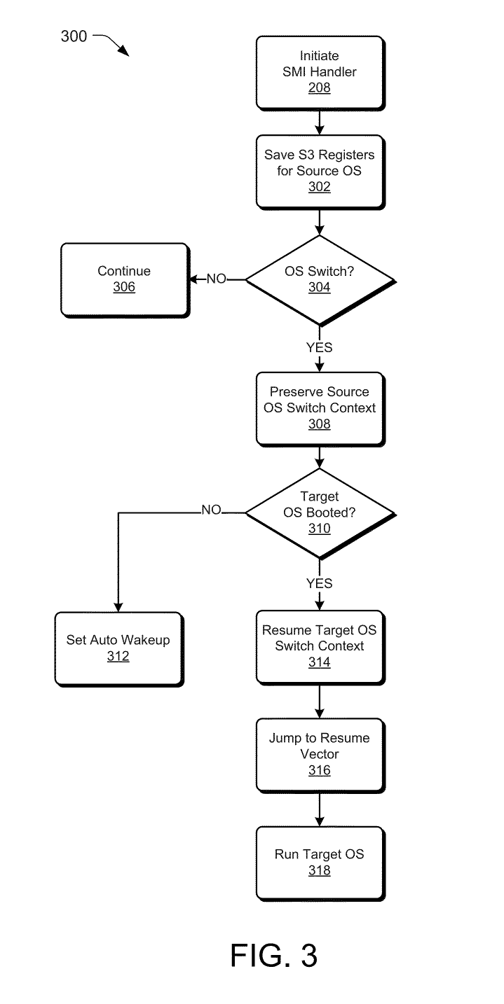

FIG. 2 shows process 200 for running an operating system when switching between operational contexts. Process 200 follows from process 100. At block 110, the OS is initiated. At block 202, a determination is made if a triggering event, such as closing a lid on a laptop, or a hot key has been pressed to initiate a switch to a different OS running a different operational context (i.e., another operational context running on a different OS). If the determination is that there is no switch to a different OS, following the “NO” branch of block 202, the flow 200 goes back to block 110, Otherwise, following the “YES” branch of block 202, at block 204, the OS switch flag is set. At block 206, a Standby state or S3 state is triggered. By triggering an S3 state, at block 208, a SMI handler is invoked or initiated (further described below in the discussion regarding FIG. 3). The SMI handler is particularly directed to detecting and addressing “errors” when booting an OS.

Performing block 110 also involves a determination as to whether the OS switch flag has been set. at block 210. Following the “NO” branch of block 210, the flow 200 goes back to block 110. If the OS flag switch has been set, following the “YES” branch of block 210, the flow 200 goes to block 206 to trigger a Standby or S3 state.

FIG. 3 shows an example process 300 to initiate a system management (mode) interrupt or SMI handler, By triggering the Standby or S3 state, a SMI Handler is initiated at block 208. The process 300, including the blocks such invoking the SMI handler may be based on Advanced Configuration & Power Interface or ACPI standards. At block 302, the S3 registers are saved to memory (i.e., RAM) for the source OS, including saving context information. A Standby or S3 state in contrast to a Deep Sleep state or S4 state, allows the computing device to become up and running more quickly than in Deep Sleep state or S4 state. In other words, to get to an operational state, initializing is minimal in Standby or S3 slate, when compared to Deep Sleep state or S4 state.

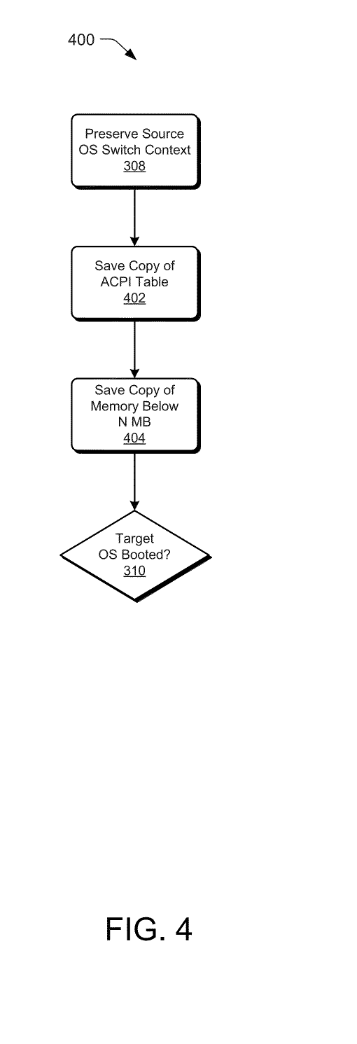

At block 304, a determination is made whether to switch OS. If the determination is not to switch OS, following the “NO” branch of block 304, at block 306 the process continues. If the OS is to be switched, following the “YES” branch of block 304, at block 308, OS switch context is preserved or saved (further described below in the discussion regarding FIG. 4).

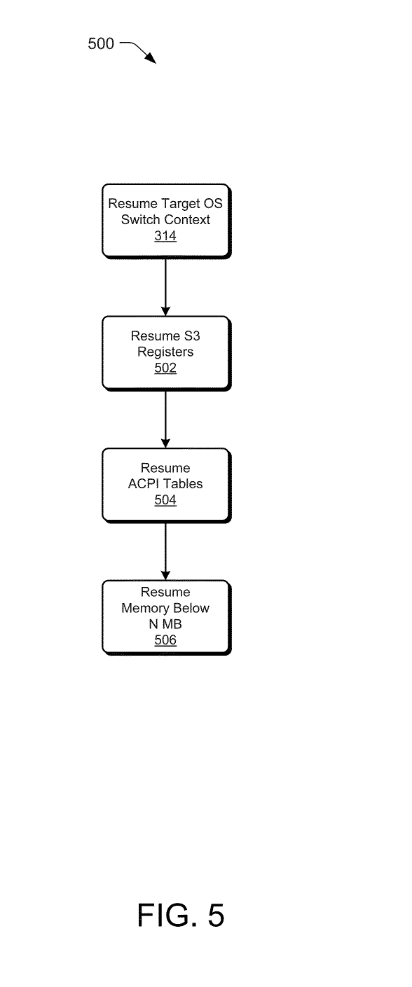

At block 310, a determination is made as to whether the target OS is to be booted. If the target OS is not to be booted, following the “NO” branch of block 310, then at block 312, the auto wakeup for the OS is set. If that target OS is to be booted, following the “YES” branch of block 310, then at block 314, the target OS switch context is resumed (described below in the discussion regarding FIG. 5).

At block 316, a jump to a resume vector of the target OS is performed (further described below in the discussion regarding FTC. 6). When switching contexts, software code flow is effectively started from a computing device's initial reset vector. BIOS code is ran, and as part of a normal resume code path for a standby or S3 state, instead of running a target OS's loader (i.e., the OS is effectively loaded), a jump is performed to the OS resume vector which may be stored in a location in memory. Such code may he implemented by means in which the OS wakes itself up from an existing standby or S3 state. The code may be ran when the BIOS is attempting to wake the OS back up. At block 318. the target OS is run. This may include running the desired operational context.

FIG. 4 shows an example process 400 to preserve switched operating system context when switching between operational contexts. Following block 308, per defined ACPI requirements, at block 402 a copy of values in an ACPI table is saved. At block 404, designated memory reserved for the source OS context is saved or preserved in order to be used or referred to later. in particular implementations, a specific area in memory (i.e., RAM), is designated. For example, the memory below “N” MB in RAM is designated. The process 400 then goes back to the determining if the target OS is to be booted at block 310.

FIG. 5 shows an example process 500 to resume target switch context when switching between operational contexts. Following block 314, at block 502 a resumption is made as to the saved Standby or S3 Mate registers. At block 504, the saved ACPI tables are called up and resumed. At block 506, the designated memory (i.e., memory as saved for example at block 404), is called up and implemented.

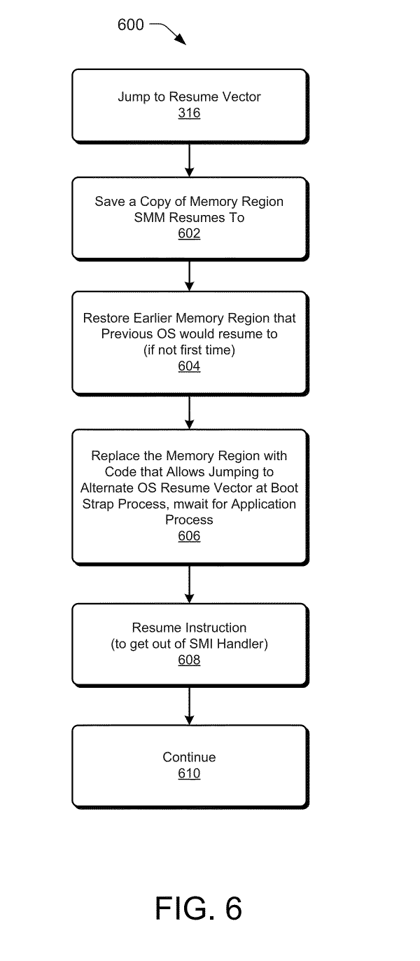

FIG. 6 is an example process 600 to jump to a resume operating system resume vector when switching between operational contexts. Process 600 may be implemented as logic within the RIOS. Such logic may be used to manage multiple OS which are in standby mode. The BIOS controls or determines into which OS resume vector is launched. Therefore, if contexts are switched, the current resume vector is switched with the prior resume vector. In order to perform the switch, the location of current resume vector may be written to a temporary store, and restore the old resume vector which is active for a new destination OS, and establish that as the current resume vector and ultimately use the old resume vector. This may provide the ability to safely “ping-pong” back and forth between various resume vectors without losing context. In certain implementations, a reserved memory region may be implemented to maintain this data within the context of the BIOS. The BIOS being an entity in the computing platform which understands switching of contexts. Following block 316, where a jump is made to a resume vector of the OS, at block 602, a save is performed for a copy of a memory region where SMM resumes to when called. in particular, the save performed is the old resume vector data along with any other necessary data associated with the OS that is switched from. This may avoid the loss of data and enables an ability to restore and switch back in the future. At block 604, if not performed previously, a restore is performed for an earlier memory region that a previous OS would resume to. Memory regions that are used may be considered as a private reserved memory store within the BIOS, such that sufficient space is allocated to reserve an “N” number of contexts, and avoids having to overwrite other operational contexts, since each operational context effectively has a “slot” reserved for each. For example, if two operational contexts exist, there may be a slot 1 for operational context 1 and a slot 2 for operational context 2. Therefore, when switching from operation context 1 to operational context 2, active information associated with operational context 1 may be saved into slot #1, Data used for active current active settings, such as slot #2's resume vector, may be read from slot #2. At block 606, a bootstrap process is performed that includes replacing the memory region with code that allows jumping to an alternate OS resume vector. In particular, at block 606, data in the respective private store or “slot” is used to establish current behavior. Therefore, private store or “slots” may be considered as “backup” of the data. The real configuration data (e.g. current resume information) is programmed with the data from such backup. A command, such as “mwait” may be used for the application process to set power state. At block 608, a resume instruction is initiated to get out of the SMI handler process. The SMI handler process may be initiated by various occurrences:

however, in this example the SMI handler process is initiated as defined by an ACPI S state transition that goes into the Standby or S3 state, triggering a SMI. Therefore, at block 602 is when the SMI handler is entered into, and block 608 is an exit out for the SMI handler. At block 610, the operation continues at block 318 described above. e

### BIOS Processes

As discussed, implementation may be performed using the BIOS of the computing device, In general, BIOS performs actions from “power on” to handoff to the OS of the computing device. BIOS operation may include various phases. Part of BIOS can be a Unified Extensible Firmware Interface or UEFI or EFI. Pre-EFI or PEI is an early phase of computing device BIOS initialization. Driver Execution Environment or DXE occurs in the latter half of BIOS initialization in a computing device. DXE is where in the BIOS that the OS is launched.

In a Standby or S3 state, resuming to an OS can occur in relatively quick manner, because a lot of the initialization does not need to take place again, because of the saves to memory (i.e., RAM). In Standby or S3 state, the launch may be at the PEI phase. DXE is implemented when an OS is to be booted at least once, and is part of a full BIOS initialization for each OS. An OS hoot is implemented at least once to get to Standby or S3 state.

In general, when booting up in PEI, either in S3 flow or mode, a determination is made if the boot target OS was the previous target. For example, entering S3 mode from a Windows™ OS, and coming back from the Windows™ OS. If the case is true, then a normal flow is resumed. If the case is not true, then a switch to an alternate flow or OS resume vector is performed. A determination is made if the other OS is launched and going to Standby state or S3 state. If the determination is not true, then the process goes into DXE and a normal boot flow, and launching the OS in DXE.

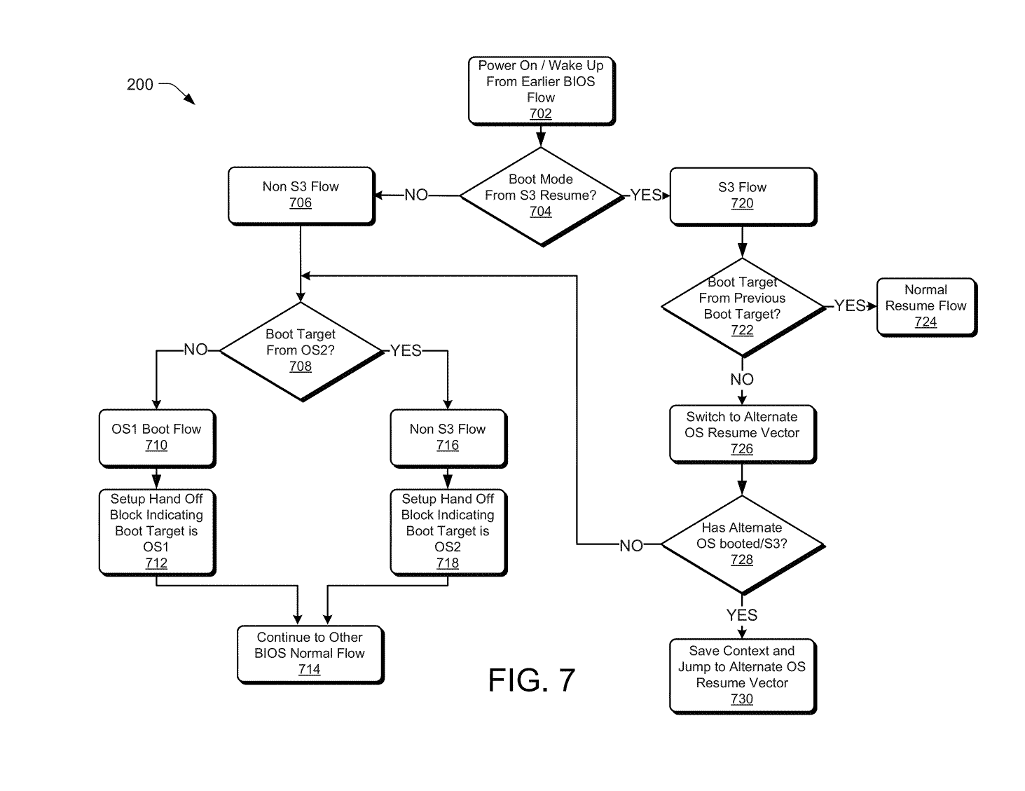

FIG. 7 is an example process 700 for waking from sleep state in pre Pre-EFI or PET when switching between operational contexts. The process 700 may be implemented by the BIOS. At block 702, power on is initialed or a wake up from an earlier BIOS flow is initiated. At block 704 a determination is made as to whether boot mode is being resumed from a Standby or S3 state.

If boot mode from Standby or S3 slate is not resumed, following the “NO” branch of block 704, at block 706, a non Standby or S3 state is performed. At block 708, a determination is made whether the boot target is from a second or other OS. Following the “NO” branch of block 708, the existing or first OS boot flow is followed. At block 712, a handoff block is set to indicate that the boot target is the existing or first OS. At block 714, the BIOS process continued. Following the “YES” branch of block 708, at block 716, a non Standby state or non S3 flow is performed. At block 718, a handoff block is set to indicate that the boot target is the second or other OS. AI block 714, the BIOS is continued.

If boot mode from Standby state or S3 slate is resumed, following the “YES” branch of block 704, at block 720, 33 flow is followed. At block 722, a determination is made as to whether the boot target is from the previous boot target. Following the “YES” branch of block 722, at block 724 normal resume flow is followed. Following the “NO” branch of block 722, a switch is performed to the alternate OS resume vector. At block 728, a determination is made if the OS booted from Standby or S3 state. Following the “NO” branch of block 728, block 708 is performed. Following the “YES” branch of 728, at block 730 context is saved and a jump is made to the alternate OS resume vector.

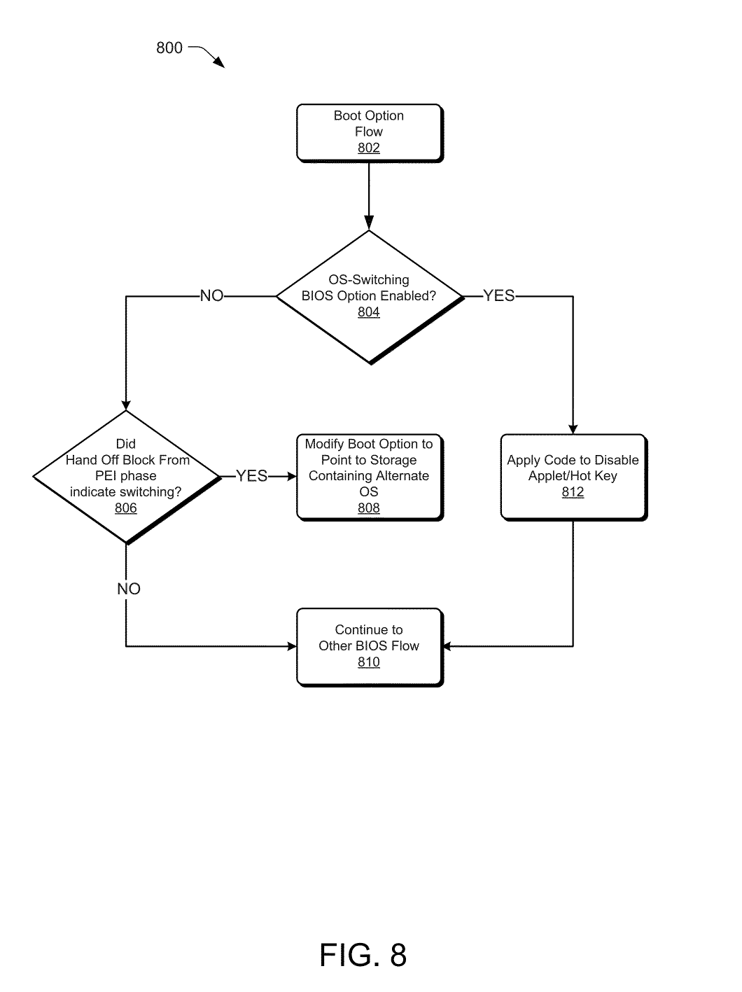

FIG. 8 is an example process 800 for waking from sleep state in DXE when switching between operational contexts. The process 800 may be implemented by the BIOS. At block 802, boot option flow is performed. At block 804 a determination is made as to whether the OS switching BIOS option is enabled. Following the “NO” branch of block 804, a determination is made at block 806 if the hand off block from the PEI phase indicates switching. Following the “YES” branch of block 806, at block 808 the boot option is modified to point to memory store that contains the alternate OS. Following the “NO” branch of block 806, at block 810, the BIOS process is continued. If the OS switching BIOS option is enabled, following the “YES” branch of block 804, code is applied to disable the initiating hot key or applet that triggered calling the operational context. At block 810 the BIOS process is continued.

### Example Computing Device

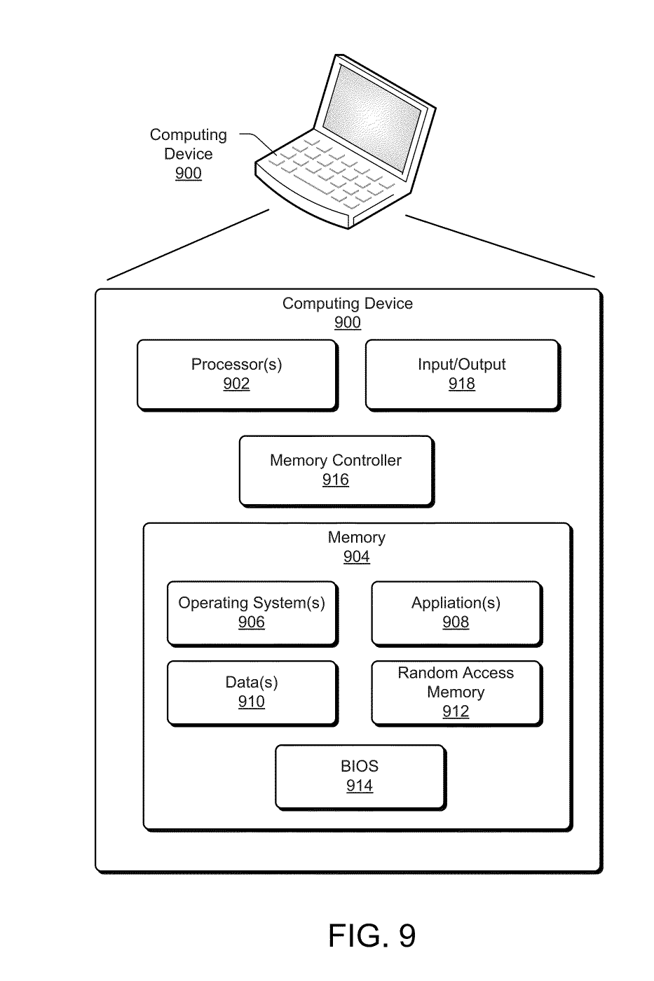

FIG. 9 shows an example computing device 900 that implements switching between operational contexts. As discussed above, computing device 900 may include various devices, such as a tablet, laptop computer, etc.

Computing device 900 includes one or more processors, processor(s) 902. Processor(s) 902 may be a single processing unit or a number of processing units, all of which may include single or multiple computing units or multiple cores. The processor(s) 902 may be implemented as one or more microprocessors, microcomputers, microcontrollers, digital signal processors, central processing units, state machines, logic circuitries, and/or any devices that manipulate signals based on operational instructions. Among other capabilities, the processor(s) 902 may be configured to fetch and execute computer-readable instructions or processor-accessible instructions stored in a memory 904 or other computer-readable storage media.

Memory 904 is an example of computer-readable storage media for storing instructions which are executed by the processor(s) 902 to perform the various functions described above. For example, memory 904 may generally include both volatile memory and non-volatile memory (e.g., RAM, ROM, or the like). Memory 904 may be referred to as memory or computer-readable storage media herein. Memory 904 is capable of storing computer-readable, processor-executable program instructions as computer program code that may be executed by the processor(s) 902 as a particular machine configured for carrying out the operations and functions described in the implementations herein.

Memory 904 may include one or more operating system(s) 906, and may store one or more applications 908. The operating system(s) 906 may be one of various known and future operating systems implemented for personal computers, audio video devices, etc. The applications 908 may include preconfigured/installed and downloadable applications. In addition, memory 904 can include data 910. Operating system(s) 906 and applications 908 may define operational contexts as discussed above.

Memory 904 particularly includes a random access memory or RAM 912 to which the above described process store information while in Standby or S3 state. Furthermore, a BIOS 914 is included in memory 904. BIOS 914 may be stored in read only memory (ROM).

Computing device 900 includes a memory controller 916. While in Standby or S3 state, operations in memory may be run using memory controller 916. The RAM 912 can be kept in self refresh mode, allowing the RAM 912. to keep minimum context to keep computing device alive. Therefore, when processor(s) 902, and other devices of computing device wake up, memory is waiting. This allows a Standby state or S3 state to he a low power consumption state compared to when an application(s) 908 is running.

The computing device can further include input/output 918 connected to various internal and external devices and peripherals, such as monitors, keyboards, pointing devices, etc. Various known and future interfaces may he included in input/output 918. In particular, input/output 918 may provide access to pre-installed or user programmed hot keys that may initiate transition to a existing or different operational context.

The example computing device 900 described herein is merely an example that is suitable for some implementations and is not intended to suggest any limitation as to the scope of use or functionality of the environments, architectures and frameworks that may implement the processes, components and features described herein.

Generally, any of the functions described with reference to the figures can be implemented using software, hardware (e.g., fixed logic circuitry) or a combination of these implementations. Program code may be stored in one or more computer-readable memory devices or other computer-readable storage devices. Thus, the processes and components described herein may be implemented by a computer program product.

As mentioned above, computer storage media includes volatile and non-volatile, removable and non-removable media implemented in any method or technology for storage of information, such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store information for access by a computing device.

### Example Memory Allocation

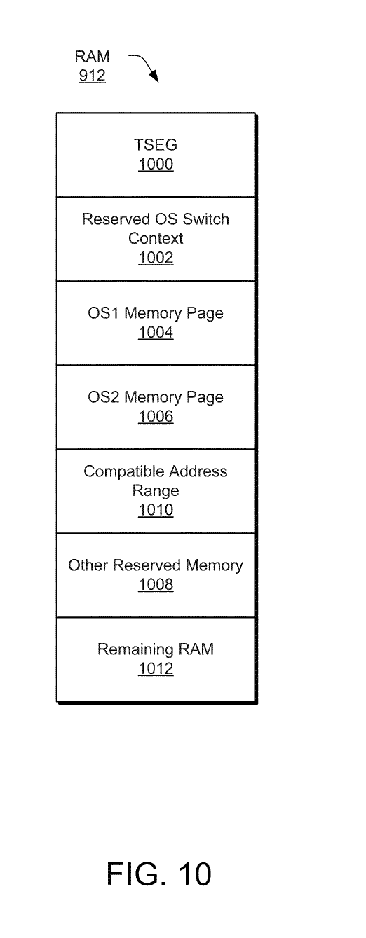

Referring to FIG. 10, RAM 912 may be allocated or have sections reserved for the information/data discussed above in regards to the processes. TSEG 1000 is a segment in memory that SMM defines for initializing the CPU or processor(s) 902. TSEG 1000 contains SMM code and logic that is associated with SMM. Reserved OS Switch Context 1002 is a region that is reserved as an overhead for BIOS to accomplish additional saving and restoring information associated with multiple operational contexts that may be switch to and from. OS1 Memory page 1004 and OS2 memory page 1006 is a section for particular OS. It is to be understood that other OS may be implemented, and sections in RAM 912 reserved for such OS. Compatible Address range 1010 are addresses to access particular OS. Section(s) of RAM 912 may be reserved for other data and information 1008 related to switching operational contexts, Remaining RAM 1012 indicates sections of RAM 912 not used for the described processes.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the various configurations may be implemented as a combined structure or component. These and other variations, modifications, additions, and improvements may fall within the scope of the invention as defined in the claims that follow.

What is claimed is:

1. A method of switching between operational contexts comprising:
under control of one or more processors configured with executable instructions,
placing a computing device in a standby power state;
determining one of multiple operating systems to launch from the standby power state; and
launching from the standby power state, a desired operational context running on the determined operating system.

2. The method of claim 1 wherein the determining the operating systems is based on a user action on the computing device.

3. The method for claim 1, wherein the determining includes switching from a previous operating system to a different operating system.

4. The method of claim 1, wherein the launching from the standby power state includes detecting an error in booting up an operating system, and booting up the determined operating system.

5. The method of claim 1, wherein the placing, determining, and launching are platform and operating system agnostic.

6. The method of claim 1 further comprising saving data to memory to perform the launching.

7. The method of claim 1 further comprising reserving memory for data to launch the multiple operating systems.

8. A computing device comprising:
one or more processors;
a memory controller configured to the one or more processors; and
memory configured to the one or more processors and memory controller, wherein the memory includes one or more operating systems, such that when the computing device is placed in a standby power state, an operating system supporting a desired operational context is launched from the standby power state.

9. The computing device of claim 8, wherein the memory controller runs operations from memory while the computing device is in standby power state.

10. The computing device of claim 8, wherein the memory includes random access memory that is allocated to launch the operating systems from standby power state.

11. The computing device of claim 8, wherein the memory includes random access memory, and data is saved to random access memory to launch the operating systems from standby power slate.

12. The computing device of claim 8, wherein the memory includes system management code to detect errors in launching an operating system, and launching the appropriate operating system for the desired operational context.

13. The computing device of claim 8 further comprising input/output interfaces connected to devices and peripherals that initiate launching an operational context.

14. The computing device of claim 8 further comprising a basic input/output system (BIOS) that supports the standby power state and wherein the desired operating system is launched.

15. The computing device of claim 14, wherein the BIOS includes various phases from which the desired operating system is launched.

16. At least one computer-readable storage medium having computer-readable instructions thereon which, when executed by a computing device, cause the computing device to perform operations comprising
placing a computing device in a standby power state;
saving data locations in memory to launch one or more operating systems supporting multiple operational contexts from the standby power state; and
launching an operating system supporting a desired operational context, from the standby power state.

17. The computer-readable storage media of claim 16, wherein the placing the computing device in standby power state and launching the operating system are based on a user action of the computing device.

18. The computer-readable storage media of claim 16, wherein the saving data locations in memory includes saving data from previous implemented operating system.

19. The computer-readable storage media of claim 16, wherein the launching includes reading from saved memory allocated to boot the one or more operating systems.

20. The computer-readable storage media of claim 16 further comprising determining system errors in boating up the operating system and launching another operating system.
